(19) United States
(12) Patent Application Publication
(10) Pub. No.: US 2024/0403834 A1
(43) Pub. Date: Dec. 5, 2024

(54) SYSTEMS AND METHODS FOR RECOMMENDING ROADWAY INFRASTRUCTURE MAINTENANCE TASKS

(71) Applicant: Woven by Toyota, Inc., Tokyo (JP)

(72) Inventor: Shunsho Kaku, Mountain View, CA (US)

(73) Assignee: Woven by Toyota, Inc., Tokyo (JP)

(21) Appl. No.: 18/327,312

(22) Filed: Jun. 1, 2023

(51) Int. Cl. G06Q 10/20; G07C 5/08

(52) U.S. Cl. CPC G06Q 10/20; G07C 5/08

(57) ABSTRACT

Systems, methods, and other embodiments described herein relate to recommending road infrastructure maintenance tasks based on vehicle sensor data and infrastructure map data. In one embodiment, a system includes a processor and a memory storing machine-readable instructions. The instructions, when executed by the processor, cause the processor to infer a perceived infrastructure element by a motorist within an environment based on sensor data collected from a sensor system of a vehicle. The instructions, when executed by the processor, also cause the processor to retrieve map data associated with the environment. The map data indicates a mapped infrastructure element. The instructions, when executed by the processor, also cause the processor to recommend a maintenance task to be performed based on the map data and the sensor data.

### TECHNICAL FIELD

The subject matter described herein relates, in general, to maintaining roadway infrastructure and, more particularly, to predicting roadway maintenance infrastructure based on 1) a map of the environment of the infrastructure and 2) data collected by a vehicle sensor.

### BACKGROUND

Roadway infrastructure elements include static objects near the roadway that facilitate vehicular travel along the roadway. Some infrastructure elements promote the ordered direction of traffic along the roadway. Examples of such infrastructure elements include traffic lights, lane markings, traffic signs, road signage, power poles, and so on. Other infrastructure elements promote the safe interaction of vehicles and pedestrians. Examples of these types of infrastructure elements include pedestrian crossing markings, pedestrian crossing lights, streetlamps, and others. Still further, some infrastructure elements are aesthetic elements of the environment. Examples include trees, shrubs, and the like.

Over time, infrastructure elements are prone to deteriorate, break down, or otherwise lose their ability to perform their intended function to promote the safe and efficient use of vehicles. For example, traffic light bulbs burn out. In another example, tree branches grow to block the visibility of traffic signage. As yet another example, lane markings fade over time. In each of these examples, the infrastructure element is not perceived by motorists and therefore the infrastructure element is unable to regulate motorist behavior. The repair and maintenance of these infrastructure elements to ensure their intended utility is a complex, time-consuming, and complicated process requiring many person-hours and significant financial expenditures.

### SUMMARY

In one embodiment, example systems and methods relate to a manner of improving roadway infrastructure by leveraging vehicle fleet sensor data.

In one embodiment, a maintenance task recommendation system for recommending infrastructure maintenance tasks is disclosed. The maintenance task recommendation system includes one or more processors and a memory communicably coupled to the one or more processors. The memory stores instructions that, when executed by the one or more processors, cause the one or more processors to infer a perceived infrastructure element by a motorist within an environment based on sensor data collected from a sensor system of a vehicle. The instructions, when executed by the one or more processors, cause the one or more processors to retrieve map data associated with the environment. The map data indicates a mapped infrastructure element. The instructions, when executed by the one or more processors, cause the one or more processors to recommend a maintenance task to be performed based on the map data and the sensor data.

In one embodiment, a non-transitory computer-readable medium for recommending infrastructure maintenance tasks and including instructions that, when executed by one or more processors, cause the one or more processors to perform one or more functions is disclosed. The instructions include instructions to collect sensor data from a sensor system of a vehicle. The instructions include instructions to infer from the sensor data a perceived infrastructure element by a motorist within an environment. The instructions include instructions to retrieve map data associated with the environment. The map data indicates a mapped infrastructure element. The instructions include instructions to recommend, using a neural network model trained to identify maintenance tasks based on the map data and the sensor data, a maintenance task to be performed based on a comparison of the map data and the sensor data.

In one embodiment, a method for recommending infrastructure maintenance tasks is disclosed. In one embodiment, the method includes collecting sensor data from a sensor system of a vehicle. The method includes inferring, from the sensor data, a perceived infrastructure element by a motorist within an environment. The method also includes retrieving map data associated with the environment. The map data indicates a mapped infrastructure element and is machine-generated based on sensor data from multiple vehicles traveling through the environment. The method also includes recommending, using a neural network model trained to identify maintenance tasks based on the map data and the sensor data, a maintenance task to be performed based on the map data and the sensor data.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a maintenance task recommendation system associated with recommending infrastructure maintenance tasks based on vehicle sensor data and map data.

FIG. 3 illustrates one embodiment of the maintenance task recommendation system of FIG. 2 in a cloud-computing environment.

FIG. 4 illustrates a flowchart for one embodiment of a method associated with recommending infrastructure maintenance tasks based on vehicle sensor data and map data.

FIG. 5 illustrates an environment for recommending infrastructure maintenance tasks based on vehicle sensor data and map data.

FIG. 6 illustrates an environment for recommending infrastructure maintenance tasks based on vehicle sensor data and map data.

### DETAILED DESCRIPTION

Systems, methods, and other embodiments associated with improving infrastructure repair and maintenance based on vehicle sensor data and map data are disclosed herein. Every day, millions of vehicles travel on roadways across the globe. Various types of roadway infrastructure elements ensure the organized, structured, and safe operation of vehicles along the roadways and the safe interaction of vehicles with pedestrians. For example, traffic lights and traffic signs ensure the organized perpendicular travel of vehicles. Streetlamps improve the visibility of the roadway and surrounding environment in low-light conditions. Other signage warns motorists of upcoming road features, such as sharp turns, which may require additional attention. Still further, some infrastructure elements ensure the safe use of the roadways by both pedestrians and vehicles. Examples of such infrastructure elements include school zone signs, crosswalk markers, and others. Still further, some infrastructure elements serve to beautify the roadway. Examples include trees, shrubs, signs, etc.

For various reasons, a user may not see the infrastructure element. As such, the utility of the infrastructure element is lost. For example, over time, infrastructure elements break down, deteriorate, or otherwise lose their ability to perform their intended function. As a few examples, traffic lightbulbs burn out, tree branches grow to block the visibility of traffic signage, and lane markings fade over time. The repair and maintenance of these infrastructure elements to ensure their intended utility is a complex, time-consuming, and complicated process requiring many person-hours and significant financial expenditures. For example, an issue is first detected by a motorist and reported to an entity with responsibility for infrastructure maintenance. A representative then travels to the site to assess and evaluate the situation. Based on the representative's assessment of the situation, a maintenance team acquires the materials needed and returns to the site to perform any repair or maintenance work. As such, this process requires multiple visits to the site and high levels of coordination to detect, assess, and repair the roadway infrastructure.

The present systems and methods automate the evaluation of periodic road maintenance tasks using a novel network. Specifically, the present systems and methods rely on vehicle sensor data and roadway map data in making such evaluations. Vehicles are equipped with sensors that facilitate perceiving other vehicles, obstacles, pedestrians, and additional aspects of a surrounding environment. For example, a vehicle may be equipped with a light detection and ranging (LIDAR) sensor that uses light to scan the surrounding environment, while logic associated with the LIDAR analyzes acquired data to detect a presence of objects and other features of the surrounding environment. In further examples, additional/alternative sensors such as cameras may be implemented to acquire information about the surrounding environment from which a system derives awareness about aspects of the surrounding environment. This sensor data is collected from multiple vehicles as the vehicles travel through a particular environment. In general, the sensor data about the environment indicates a motorist perception of the environment. For example, if a sensor does not detect an infrastructure element, it is likely that a motorist does not perceive or see it. As such, the infrastructure element may need repair and/or maintenance such that it is perceived by a user and returns to an intended operational state, i.e., aiding a user in navigating a roadway.

The sensor data is compared against map data for the particular environment to identify infrastructure elements that need repair, maintenance, or any other action to improve the intended utility of the infrastructure element. As a particular example, map data for a particular intersection may indicate a traffic sign on the side of the roadway. In this example, an environmental sensor of a vehicle traveling through the intersection does not detect the traffic sign. The lack of detection of the traffic sign by the sensor system suggests that the motorist does not see the traffic sign. This discrepancy between the map data and the environmental sensor data indicates something is wrong with the traffic sign.

In another example, the sensor data includes information about the vehicle itself, such as the vehicle speed, acceleration, deceleration, lateral movement, and the like. Again, this sensor data is collected from multiple vehicles traveling through a particular environment. This vehicle operational data is collected and compared against the map data for the environment to identify infrastructure elements that require attention. For example, map data may indicate a three-way junction (e.g., a T-intersection) between two roads. In this example, vehicle sensor data indicates that the vehicle abruptly reduces speed (e.g., the motorist slams on the brakes) as it approaches the T-intersection. This may indicate that a user is unaware of the T-intersection.

However, the present systems and methods do not simply identify that a problem exists (e.g., that a traffic sign is not being detected by vehicles or that motorists repeatedly slam on their brakes at a particular location), but also provide a recommendation based on the comparison of map data with sensor data. This may be based on several factors, including additional map data and/or historical maintenance tasks. For example, referring to the example where environmental sensor data did not detect a traffic sign indicated in the map data. The map data may also indicate a tree near the traffic sign. With this information, the system predicts that the tree has grown to block the traffic sign such that the environmental sensor does not detect the traffic sign. If the environmental sensor does not detect the traffic sign, it is likely that a motorist can also not see the traffic sign. Thus, the intended utility of the traffic sign to encourage certain driving behaviors is lost. As such, the recommendation is to send a maintenance crew to trim the trees at this location.

As another example and referring to a case where motorists slam on their brakes on approach to an obscure T-intersection, historical maintenance records may indicate that for a similar situation at another location and/or time, the addition of speed bumps and installation of warning signage reduced the incidence of slamming on the brakes. In this example, the recommendation is to send a maintenance crew to add warning signage and install speed bumps. As such, the present methods and systems not only detect road conditions based on information collected from vehicle cameras and sensors, but intelligently (using machine learning) provide recommendations of particular maintenance tasks based on vehicle sensor data as compared against map data for a particular environment.

The map upon which the recommendation is based, and the recommendation itself, may be generated from a machine learning system. The machine learning system is trained on historically-collected vehicle sensor data, data mined from past roadway infrastructure maintenance logs, and manual annotations. Over time, various discrepancies between vehicle sensor data and map data are detected as vehicles travel along the roadway. Various maintenance/repair tasks resolve these detected discrepancies. By considering past instances of detected discrepancies and the associated repairs/maintenance tasks performed, the system identifies and recommends similar repair/maintenance tasks to those historically performed to resolve a discrepancy.

The recently detected discrepancy and associated repair/maintenance tasks are then fed into the system to further train the task model to intelligently detect situations requiring attention and recommend a particular remedial action. As such, the maintenance task recommendation system may be a machine learning system that updates the map data and the task recommendation model as data is collected from vehicle sensors and infrastructure records.

In this way, the disclosed systems, methods, and other embodiments improve infrastructure maintenance by using deep learning logic to recommend a particular maintenance task based on a comparison of vehicle sensor data and map data.

As used in the present specification and in the appended claims, the term “perceived infrastructure element” refers to an infrastructure element detected by the sensor system and likely perceived by a motorist.

By comparison, as used in the present specification and in the appended claims, the term “mapped infrastructure element” refers to an infrastructure element that is included in the map data. As described below, a discrepancy between the perceived and mapped infrastructure elements triggers the maintenance task recommendation system to recommend a maintenance task or repair.

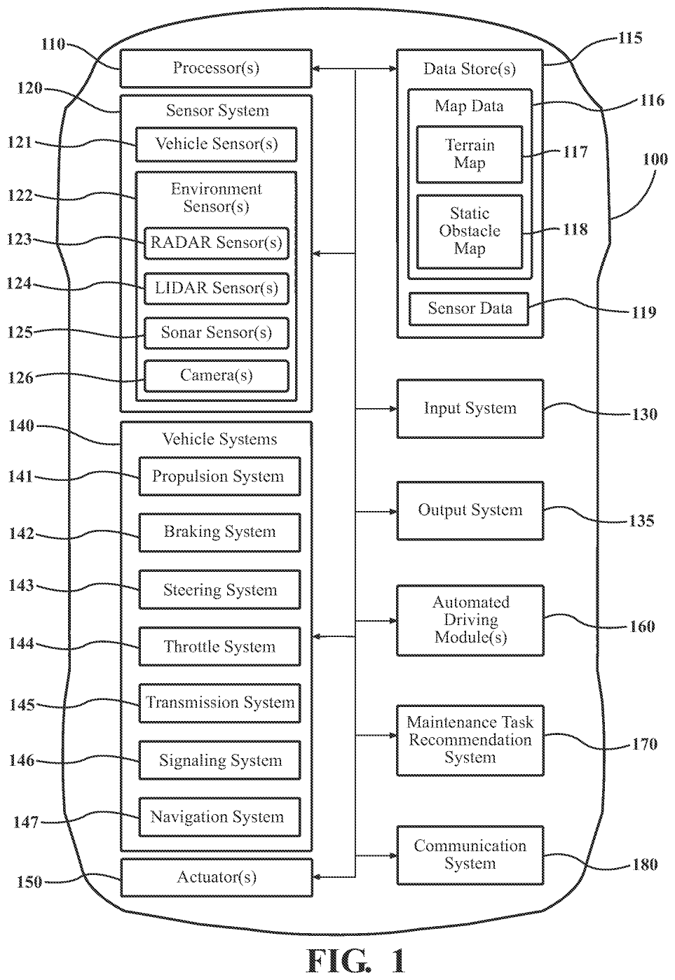

Referring to FIG. 1, an example of a vehicle 100 is illustrated. As used herein, a “vehicle” is any form of transport that may be motorized or otherwise powered. In one or more implementations, the vehicle 100 is an automobile. While arrangements will be described herein with respect to automobiles, it will be understood that embodiments are not limited to automobiles. In some implementations, the vehicle 100 may be a robotic device or a form of transport that, for example, includes sensors to perceive aspects of the surrounding environment, and thus benefits from the functionality discussed herein associated with improving infrastructure maintenance tasks and/or repairs.

The vehicle 100 also includes various elements. It will be understood that in various embodiments it may not be necessary for the vehicle 100 to have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1. it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment or other system that is remote from the vehicle 100.

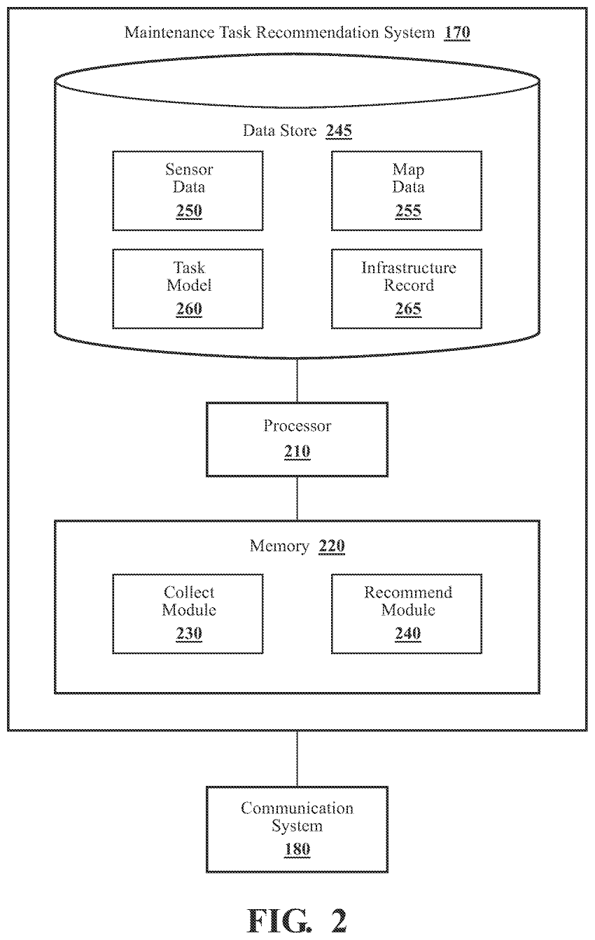

Some of the possible elements of the vehicle 100 are shown in FIG. 1 and will be described along with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 100 includes a maintenance task recommendation system 170 that is implemented to perform methods and other functions as disclosed herein relating to improving the maintenance and repair of road infrastructure elements.

As will be discussed in greater detail subsequently, the maintenance task recommendation system 170, in various embodiments, is implemented partially within the vehicle 100, and as a cloud-based service. For example, in one approach, functionality associated with at least one module of the maintenance task recommendation system 170 is implemented within the vehicle 100 while further functionality is implemented within a cloud-based computing system. Thus, the maintenance task recommendation system 170 may include a local instance at the vehicle 100 and a remote instance that functions within the cloud-based environment.

Moreover, the maintenance task recommendation system 170, as provided for within the vehicle 100, functions in cooperation with a communication system 180. In one embodiment, the communication system 180 communicates according to one or more communication standards. For example, the communication system 180 can include multiple different antennas/transceivers and/or other hardware elements for communicating at different frequencies and according to respective protocols. The communication system 180, in one arrangement, communicates via a communication protocol, such as a WiFi, DSRC, V2I, V2V, or another suitable protocol for communicating between the vehicle 100 and other entities in the cloud environment. Moreover, the communication system 180, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 100 communicating with various remote devices (e.g., a cloud-based server). In any case, the maintenance task recommendation system 170 can leverage various wireless communication technologies to provide communications to other entities, such as members of the cloud-computing environment.

With reference to FIG. 2, one embodiment of the maintenance task recommendation system 170 of FIG. 1 is further illustrated. The maintenance task recommendation system 170 may be disposed 1) locally on the vehicle 100, 2) remotely from the vehicle 100, such as in a remote or cloud-based computing system, or 3) distributed across the vehicle 100 and the remote or cloud-based computing system. That is, in one example, the maintenance task recommendation system 170, along with the data store 245, processor 210, and memory 220 are remote from the vehicles 100. In this example, the maintenance task recommendation system 170 collects the sensor data 250 from the vehicle 100 through the communication system 180.

The maintenance task recommendation system 170 is shown as including a processor 210. Accordingly, the processor 210 may be a part of the maintenance task recommendation system 170, the maintenance task recommendation system 170 may include a separate processor from the processor 110 of the vehicle 100, or the maintenance task recommendation system 170 may access the processor 110 through a data bus or another communication path that is separate from the vehicle 100. In one embodiment, the maintenance task recommendation system 170 includes a memory 220 that stores a collect module 230 and a recommend module 240. The memory 220 is a random-access memory (RAM), read-only memory (ROM), a hard-disk drive, a flash memory, or another suitable memory for storing the modules 230 and 240. The modules 230 and 240 are, for example, computer-readable instructions that when executed by the processor 210 cause the processor 210 to perform the various functions disclosed herein. In alternative arrangements, the modules 230 and 240 are independent elements from the memory 220 that are, for example, comprised of hardware elements. Thus, the modules 230 and 240 are alternatively ASICs, hardware-based controllers, a composition of logic gates, or another hardware-based solution.

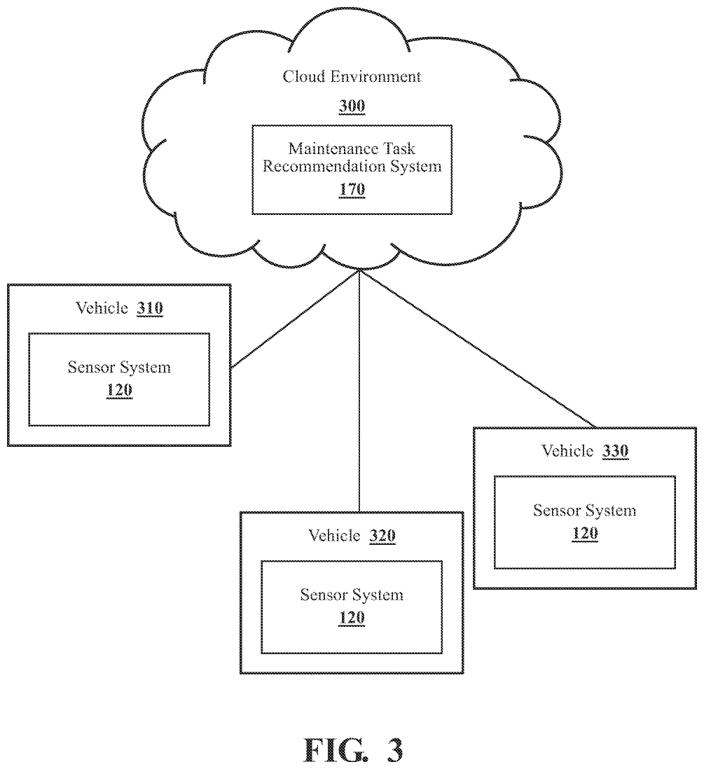

The maintenance task recommendation system 170 as illustrated in FIG. 2 is generally an abstracted form of the maintenance task recommendation system 170 as may be implemented between the vehicle 100 and a cloud-computing environment. FIG. 3 illustrates one example of a cloud-computing environment 300 that may be implemented along with the maintenance task recommendation system 170. As illustrated in FIG. 3, the maintenance task recommendation system 170 is embodied at least in part within the cloud-computing environment 300.

In one or more approaches, the cloud environment 300 may facilitate communications between multiple different vehicles to acquire and distribute information between vehicles 310, 320, and 330.

Accordingly, as shown, the maintenance task recommendation system 170 may include separate instances within one or more entities of the cloud-based environment 300, such as servers, and also instances within vehicles that function cooperatively to acquire, analyze, and distribute the noted information. In a further aspect, the entities that implement the maintenance task recommendation system 170 within the cloud-based environment 300 may vary beyond transportation-related devices and encompass mobile devices (e.g., smartphones), and other devices that may be carried by an individual within a vehicle, and thereby can function in cooperation with the vehicle 100. Thus, the set of entities that function in coordination with the cloud environment 300 may be varied.

The cloud-based environment 300 itself, as previously noted, is a dynamic environment that comprises cloud members that are routinely migrating into and out of a geographic area. In general, the geographic area, as discussed herein, is associated with a broad area, such as a city and surrounding suburbs. In any case, the area associated with the cloud environment 300 can vary according to a particular implementation but generally extends across a wide geographic area.

Moreover, in one embodiment, the maintenance task recommendation system 170 includes the data store 245. The data store 245 is, in one embodiment, an electronic data structure stored in the memory 220 or another data storage device and that is configured with routines that can be executed by the processor 210 for analyzing stored data, providing stored data, organizing stored data, and so on. Thus, in one embodiment, the data store 245 stores data used by the modules 230 and 240 in executing various functions. In one embodiment, the data store 245 stores the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on.

In an example, the sensor data 250 is an example of the sensor data 119 depicted in FIG. 1 and described in detail below. That is, the vehicle 100 includes 1) environmental sensors 122 which detect objects surrounding the vehicle 100 and 2) vehicle sensors 121 which detect information about the vehicle 100 itself. This sensor data 250 provides an inference of motorist perception of the environment and is used to predict and recommend specific infrastructure maintenance tasks and repairs.

As described above, the sensor data 250 suggests the motorist/vehicle perception of infrastructure elements within an environment. The sensor data may include images or other environmental observations captured by the environmental sensors 122 of the vehicle 100. For example, camera(s) mounted to the vehicle 100 capture images of static objects in the environment, including infrastructure elements along the roadway. The infrastructure elements identified by the sensor system 120 are referred to as perceived infrastructure elements, indicating their likely perception by a motorist. As will be described below, the images, or other sensor data, of perceived infrastructure elements along the roadway are compared against mapped infrastructure elements in the map data 255 to identify road infrastructure repairs/maintenance tasks.

The images of the environment are also used to update and maintain the map data 255. That is, the infrastructure of a road may change over time, and updates to the map data 255 to reflect these changes may be based on received sensor data 250. As an example, sensor data 250 from multiple vehicles indicates a recently-installed traffic light at an intersection. Responsive to such, the map data 255 is updated to indicate the traffic light at the intersection. As such, over time an accurate depiction of the environment is included in the map data 255 as provided by the sensor systems 120 of the various vehicles 100 that travel through the environment.

In another example, the sensor data 250 is vehicle operational data which provides evidence as to whether or not the motorist of the vehicle perceived the infrastructure element. For example, vehicle operational data indicating that a driver did not slow down upon approaching a stop sign may indicate that the motorist did not perceive the stop sign. Examples of vehicle operational data include vehicle location, speed, acceleration, deceleration, lateral movement, etc. As with the images of the environment, vehicle operational sensor data 250 is compared against the map data 255 to identify road infrastructure repairs/maintenance tasks.

In one embodiment, the data store 245 further includes map data 255. The map data may be an example of the map data 116 depicted in FIG. 1. The map data 255 includes maps of one or more geographic areas in at least one approach. In some instances, the map data 255 can include information about roads, traffic control devices, road markings, structures, features, and/or landmarks in the one or more geographic areas. In one or more arrangements, the map data 255 can include one or more terrain maps 117 and/or one or more static object map(s) 118. As described above, the map data 255 may be generated from sensor data 250 collected from a fleet of vehicles 100.

In an example, the collect module 230 is a machine learning module that identifies static objects, such as infrastructure objects, while excluding pedestrians and other non-stationary, non-infrastructure elements from the map data 255. That is, the collect module 230, using a variety of mechanisms including image analysis and video analysis, differentiates static objects, such as infrastructure elements, from dynamic objects, such as pedestrians and other vehicles. Over time, the map data 255 is updated as new sensor data is received. As such, the map data 255 represents an accurate real-time depiction of the roadway environment.

The data store 245 further includes a task model 260 that identifies a task to be recommended based on the sensor data 250 and the map data 255. As described above, a maintenance task is recommended based on a comparison of sensor data 250 and map data 255. As such, the task model 260 includes the logic which recommends a particular remedial action to be performed given specific sensor data 250 and map data 255. As will be described below, the recommend module 240, in cooperation with the task model 260, may be a machine learning system that intelligently determines a task to be performed.

The data store 245 further includes infrastructure records 265 for various infrastructure elements. In general, the infrastructure records 265 indicate the status of the mapped infrastructure elements. The infrastructure record 265 includes information such as installation date, the location of the mapped infrastructure element, past identified issues associated with the mapped infrastructure element, and details regarding past maintenance tasks and repairs, including dates and context of the repair, among others. While particular reference is made to particular fields of the infrastructure record 265, such records may include any other information regarding the status and/or history of a respective mapped infrastructure element.

Such information is further used by the recommend module 240, in cooperation with the task model 260, to recommend a particular maintenance task. As an example, it may be that vehicle environmental sensor 122 does not detect a traffic sign at a particular location while map data 255 indicates that there should be a traffic sign at the particular location. When an infrastructure record 265 indicates that the traffic sign was removed, the map data 255 is updated to reflect the removal of the traffic sign. In this example, no maintenance task is recommended. By comparison, if the infrastructure record 265 indicates that a traffic sign was recently installed, the map data 255 is updated to reflect the installation. Again, in this example, no maintenance task is recommended.

As another example, the infrastructure record 265 indicates that a traffic sign should be at the particular location. In this example, the map data 255 also indicates a tree near the traffic sign. Given 1) the presence of the traffic sign in both the map data 255 and the infrastructure record 265, 2) the lack of a detected traffic sign by the environmental sensor 122, and 3) the identification of a nearby tree, the recommend module 240 may identify a predicted overgrowth of the tree as blocking the traffic sign. The recommend module 240 then recommends a tree-trimming remedial action. As such, the infrastructure record 265 provides another data point by which the recommend module 240 intelligently recommends an infrastructure maintenance task.

With continued reference to FIG. 2, the collect module 230 generally includes instructions that function to control the processor 210 to receive data inputs from one or more sensors of the vehicle 100. The inputs are, in one embodiment, observations (e.g., images) of one or more objects in an environment proximate to the vehicle 100 and/or other aspects about the surroundings. As provided for herein, the collect module 230, in one embodiment, acquires sensor data 250 that includes at least camera images. In further arrangements, the collect module 230 acquires the sensor data 250 from further sensors such as a radar 123, a LiDAR 124, and other sensors as may be suitable for identifying static objects and infrastructure elements within the environment.

Accordingly, the collect module 230, in one embodiment, controls the respective sensors to provide the data inputs in the form of the sensor data 250. Additionally, while the collect module 230 is discussed as controlling the various sensors to provide the sensor data 250, in one or more embodiments, the collect module 230 can employ other techniques to acquire the sensor data 250 that are either active or passive. For example, the collect module 230 may passively sniff the sensor data 250 from a stream of electronic information provided by the various sensors to further components within the vehicle 100. Moreover, the collect module 230 can undertake various approaches to fuse data from multiple sensors when providing the sensor data 250 and/or from sensor data acquired over a wireless communication link (e.g., v2v) from one or more of the surrounding vehicles. Thus, the sensor data 250, in one embodiment, represents a combination of perceptions acquired from multiple sensors.

Moreover, the collect module 230, in one embodiment, controls the sensors to acquire the sensor data 250 about an area that encompasses 360 degrees about the vehicle 100 in order to provide a comprehensive assessment of the surrounding environment. Of course, in alternative embodiments, the collect module 230 may acquire the sensor data about a forward direction alone when, for example, the vehicle 100 is not equipped with further sensors to include additional regions about the vehicle and/or the additional regions are not scanned due to other reasons (e.g., unnecessary due to known current conditions). As described above, the collect module 230 receives this information via the communication system 180. In the case when the maintenance task recommendation system 170 is remote from the vehicle 100, the sensor data 250 is received via a wireless communication system 180.

In one approach, the collect module 230 implements and/or otherwise uses a machine learning algorithm. In one configuration, the machine learning algorithm is embedded within the collect module 230, such as a convolutional neural network (CNN), to generate the map data 255 from the sensor data 250. Of course, in further aspects, the collect module 230 may employ different machine learning algorithms or implements different approaches for performing the map generation which can include deep convolutional encoder-decoder architectures, a multi-scale context aggregation approach using dilated convolutions, or another suitable approach that generates map data 255 for the infrastructure objects indicated in the sensor data 250. Whichever particular approach the collect module 230 implements, the collect module 230 provides an output of map data 255 identifying objects represented in the sensor data 250. In this way, an accurate map of the roadway is generated, which is up-to-date based on the continuous reception of sensor data 250.

The recommend module 240, in one embodiment, includes instructions that cause the processor 210 to 1) retrieve map data 255 associated with the environment and 2) recommend a maintenance task to be performed based on the map data 255 and the sensor data 250. As described above, the recommended repair/maintenance task may take a variety of forms. In one example, the recommend module 240 recommends a repair of a mapped infrastructure element within the environment. In another example, the repair may be an environmental repair to increase the visibility of a mapped infrastructure element within the environment. Still further, the recommendation may be to repair a non-road surface infrastructure element.

As described above, the sensor data 250 may take a variety of forms and the recommend module 240 makes a recommendation based on the type of sensor data 250. For example, when the sensor data 250 includes images of the environment, the recommend module 240 recommends the maintenance task based on a detected discrepancy between the map data 255 and the images of the environment. Specifically, the recommend module 240 identifies a mapped infrastructure element indicated in the map data 255 but not captured in an image of the environment of the vehicle 100. Such a discrepancy indicates a problem with the infrastructure element, such as the infrastructure element being damaged, blocked from view, or otherwise obscured. For example, a streetlamp in the map data 255 may not be found in the sensor data 250 from a vehicle(s) 100. This may indicate that the streetlamp has fallen over. In another example, a traffic light represented in the map data 255 may not be found in the sensor data 250 from a vehicle(s) 100. This may indicate that tree limbs block the traffic light.

In an example where the sensor data 250 includes vehicle operational data, the recommend module 240 recommends the maintenance task based on the vehicle operational data. For example, sensor data 250 may indicate that vehicles 100 rapidly decelerate at the same location along a roadway. In this example, the map data 255 indicates a crosswalk at this location. When viewed together, this information may indicate that motorists do not see, or fail to fully appreciate, the crosswalk marking. As another example, vehicle operational data may indicate that vehicles 100 swerve at a particular location on the road. In this example, the map data 255 indicates a storm drain at this location. As such, the recommend module 240 may identify a potential issue with the storm drain that should be repaired.

Other systems that do not rely on a map of the environment cannot identify a particular maintenance task to recommend based on vehicle behavior. That is, the swerving behavior could indicate a driver is avoiding 1) a pedestrian, 2) a vehicle at the side of the road, or 3) an issue with the storm drain. Non-map-based systems that monitor vehicle behavior may not be able to identify a cause of the behavior and recommend an action based on such. In other words, the map data 255 provides a ground truth against which vehicle behavior is compared to recommend specific maintenance tasks and/or repairs.

While particular reference is made to recommending maintenance tasks based on a single particular type of sensor data 250, in some examples, the recommend module 240 provides a recommendation based on both types of sensor data 250 (e.g., images of the environment and vehicle operational data) in addition to other types of sensor data 250.

As described above, the recommend module 240 may consider other sources in recommending a particular maintenance task. For example, the data store 245 may include infrastructure records 265 that indicate the status of the various mapped infrastructure elements. In this example, the recommendation is further based on the infrastructure record 265. For example, vehicle operational data may indicate that vehicles 100 are not slowing down at a pedestrian crossing in low-light conditions. In this example, map data 255 indicates a streetlamp is present in the area and an infrastructure record 265 indicates that based on the installation date, the streetlamp bulb may be due to be replaced. As such, the recommendation module 240 may output a recommended task of replacing the bulb.

In another example, the recommend module 240 retrieves an annotation regarding a past maintenance task and recommends a maintenance task based on the annotation. In an example, the annotation indicates a repair task that was performed and in some examples the subsequent sensor data 250 in the vicinity of the repair. For example, responsive to vehicles sharply decelerating and swerving upon approach to a T-intersection (indicating the motorist did not see the T-intersection and swerved to miss approaching vehicles), an annotation may indicate that a mirror was placed at the intersection to provide greater visibility of the cross-street. The annotation may further reference subsequently-collected sensor data 250 which indicates a decline in the behavior of sharply decelerating and swerving upon approach to the T-intersection. As such, when a similarly detected circumstance arises (i.e., vehicles sharply decelerating and swerving upon approach to a T-intersection), the recommend module 240 may similarly recommend placing a mirror at the second T-intersection based on the task-identifying annotation.

In selecting the recommendation, the recommend module 240, in combination with the task model 260, may consider the similarity of a repair-triggering event with historically collected data. That is, the recommend module 240 recommends a particular maintenance task based on a similarity between the sensor data 250 and historical sensor data collected from other vehicles passing through the environment. That is, the data store 245 includes 1) a list of circumstances that trigger remedial action and 2) the remedial actions that were performed. The data store 245 also includes post-remedial action sensor data. From this subsequently-captured sensor data, the task model 260 determines the efficacy of specific remedial actions. The recommend module 240, upon detection of similar circumstances to a circumstance previously encountered, recommends the remedial action that has the highest likelihood of resolving an issue based on the efficacy of past actions.

It should be appreciated that the recommend module 240, in combination with the task model 260, can form a computational model such as a neural network model. In any case, the recommend module 240, when implemented with a neural network model or another model, in one embodiment, implements functional aspects of the task model 260 while further aspects, such as learned weights, may be stored within the data store 245. Accordingly, the task model 260 is generally integrated with the recommend module 240 as a cohesive functional structure.

In one or more configurations, the maintenance task recommendation system 170 implements one or more machine learning algorithms. As described herein, a machine learning algorithm includes but is not limited to deep neural networks (DNN), including transformer networks, convolutional neural networks, recurrent neural networks (RNN), etc., Support Vector Machines (SVM), clustering algorithms, Hidden Markov Models, and so on. It should be appreciated that the separate forms of machine learning algorithms may have distinct applications, such as agent modeling, machine perception, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the maintenance task recommendation system 170 or another system generally trains the machine learning algorithm according to a particular training approach, which may include supervised training, self-supervised training, reinforcement learning, and so on. In contrast to training/learning of the machine learning algorithm, the maintenance task recommendation system 170 implements the machine learning algorithm to perform inference. Thus, the general use of the machine learning algorithm is described as inference.

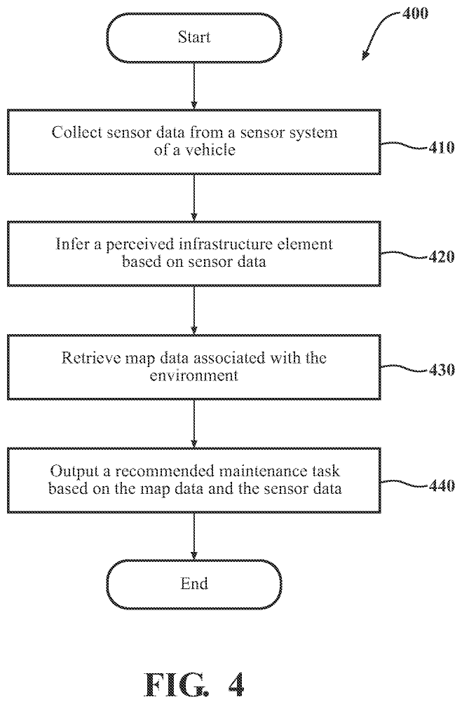

Additional aspects of infrastructure maintenance efficiency will be discussed in relation to FIG. 4. FIG. 4 illustrates a flowchart of a method 400 that is associated with recommending infrastructure maintenance tasks/repairs based on vehicle sensor data 250 and infrastructure map data 255. Method 400 will be discussed from the perspective of the maintenance task recommendation system 170 of FIGS. 1, and 2. While method 400 is discussed in combination with the maintenance task recommendation system 170, it should be appreciated that the method 400 is not limited to being implemented within the maintenance task recommendation system 170 but is instead one example of a system that may implement the method 400.

At 410, the collect module 230 controls the sensor system 120 to acquire the sensor data 250. In one embodiment, the collect module 230 communicates with the radar sensor 123 and the camera 126 of the vehicle 100 to observe the surrounding environment. Alternatively, or additionally, the collect module 230 communicates with the camera 126 and the LiDAR 124 or another set of sensors to acquire the sensor data 250. As part of controlling the sensors to acquire the sensor data 250, it is generally understood that the sensors acquire the sensor data 250 of a region around the ego vehicle 100 with data acquired from different types of sensors generally overlapping in order to provide for a comprehensive sampling of the surrounding environment at each time step. In general, the sensor data 250 need not be of the exact same bounded region in the surrounding environment but should include a sufficient area of overlap such that distinct aspects of the area can be correlated. Thus, the collect module 230, in one embodiment, controls the sensors to acquire the sensor data 250 of the surrounding environment.

Moreover, in further embodiments, the collect module 230 controls the sensors to acquire the sensor data 250 at successive iterations or time steps. Thus, the maintenance task recommendation system 170, in one embodiment, iteratively executes the functions discussed at block 410 to acquire the sensor data 250 and provide information therefrom. Furthermore, the collect module 230, in one embodiment, executes one or more of the noted functions in parallel for separate observations in order to maintain updated perceptions. Additionally, as previously noted, the collect module 230, when acquiring data from multiple sensors, fuses the data together to form the sensor data 250 and to provide for improved determinations of detection, location, and so on.

At 420, the maintenance task recommendation system 170 infers a perceived infrastructure element by a motorist within the environment based on the collected sensor data 250. For example, the detection of a traffic sign by the sensor system 120 indicates the traffic sign is unobscured and within the field of view of, and likely perceived by, the motorist. By comparison, a missing traffic sign, which would not be viewable by a motorist, would not be detected by the sensor system 120. In other words, the sensor data 250 provides a window into which infrastructure elements are perceived by motorists. Specifically, undetected infrastructure elements are not perceived by a motorist, while detected infrastructure elements are more likely perceived by the motorist.

At 430, the recommend module 240 retrieves map data 255 associated with the environment. As described above, the map data 255 indicates mapped infrastructure elements within the environment and is machine-generated based on sensor data 250 from multiple vehicles traveling through the environment. That is, the map data 255 is built over time from sensor data 250 retrieved from various vehicles 100. That sensor data is merged, meshed, or otherwise combined to form map data 255 which indicates stationary objects such as infrastructure elements. As described above, in generating the map data 255, the collect module 230 may implement machine learning to identify and label the detected static objects.

At step 440, the recommend module 240 outputs a recommended maintenance task based on the map data 255 and the sensor data 250. The recommendation is based on many factors. For example, the similarity between the sensor data 250 and historical sensor data, a previously performed maintenance task, an efficacy of the previously performed maintenance task, and an infrastructure record indicating the state of the infrastructure element and other infrastructure elements within the environment.

In an example, once the maintenance task/repair has been carried out, the task model 260 is trained based on the completed maintenance task and associated sensor data 250. That is, the actions of the maintenance crew may be recorded in the infrastructure record 265. Pre- and post-maintenance task sensor data 250 may also be recorded such that the efficacy of the particular maintenance task is ascertainable. From this information, the recommend module 240 refines the recommendation process based on the additional data. That is to say, the present maintenance task recommendation system 170 provides up-to-date, real-time map data 255 of the environment and is continuously trained and refined based on past practices to ensure the infrastructure elements are maintained in a time and cost-effective manner.

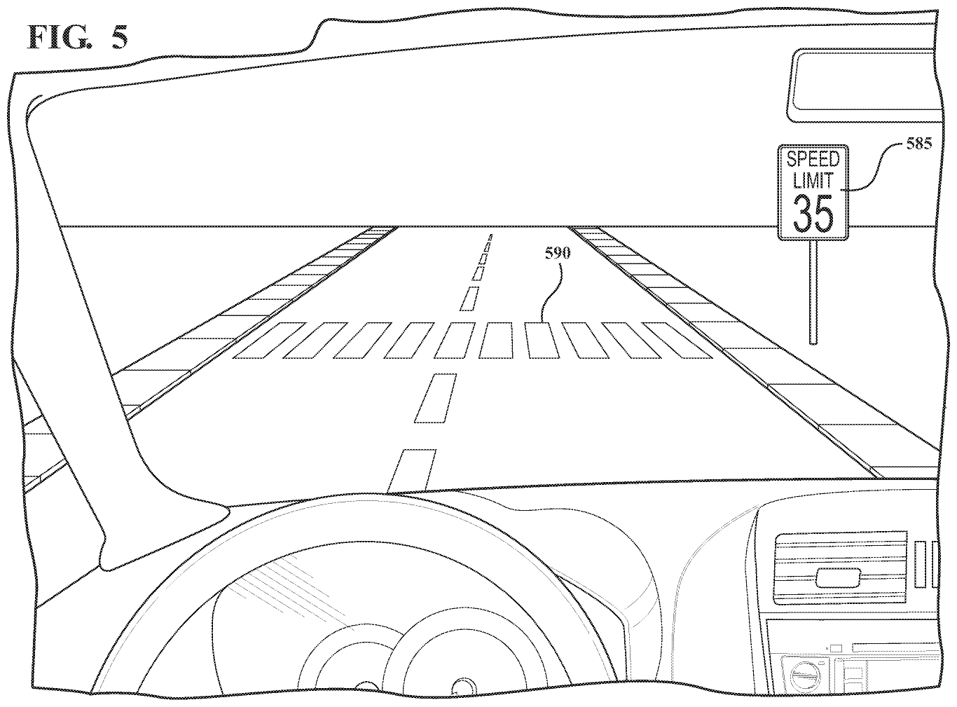

FIG. 5 illustrates an environment for recommending infrastructure maintenance tasks based on vehicle sensor data 250 and infrastructure map data 255. In the example depicted in FIG. 5, the roadway includes a speed limit sign 585 and a crosswalk 590. In this example, the sensor system 120 of the vehicle 100 may detect the speed limit sign 585 and the crosswalk 590, indicating that such are likely perceived by the motorist. That is, the speed limit sign 585 and the crosswalk 590 are perceived infrastructure elements.

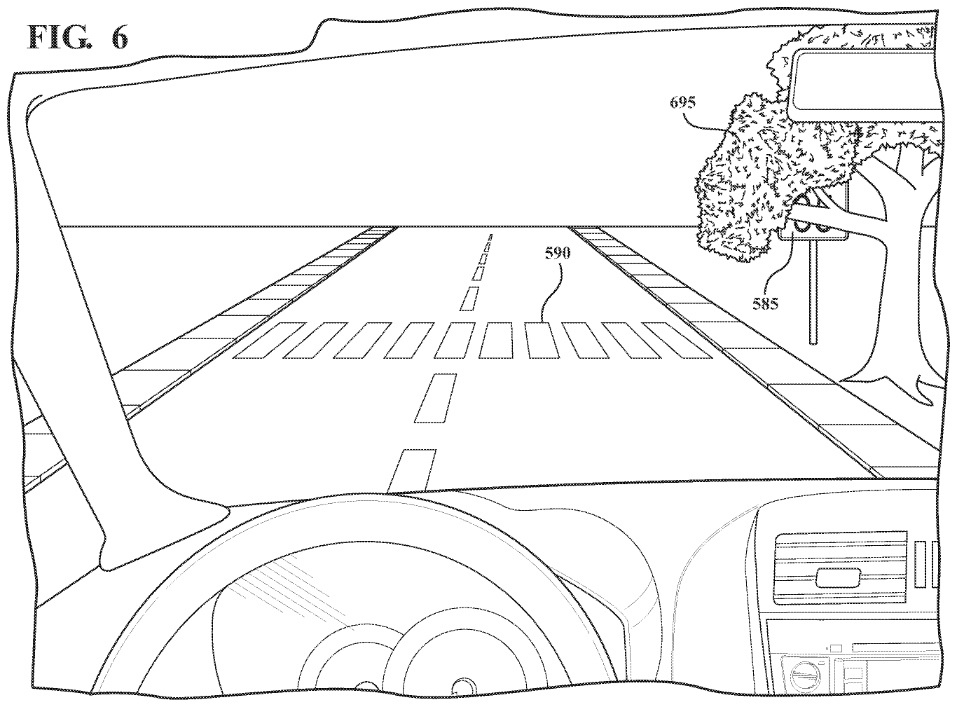

FIG. 6 illustrates an environment for recommending infrastructure maintenance tasks based on vehicle sensor data 250 and infrastructure map data 255. As depicted in FIG. 6, another infrastructure element, a tree 695, may be blocking the speed limit sign 585. As such, sensor data 250 from the sensor system 120 may not indicate the speed limit sign 585. In this example, the speed limit sign 585 is a mapped infrastructure element but not a perceived infrastructure element. Moreover, vehicle operational data may indicate that the vehicle 100 is traveling faster than the posted speed limit. Based on 1) the vehicle operational data indicating a traveling speed greater than the speed limit, 2) map data 255 indicating the speed limit sign 585 and a tree 695 in the vicinity of the speed limit sign 585, and 3) the sensor system 120 not detecting the speed limit sign 585, the recommend module 240 transmits a recommendation that the tree 695 should be trimmed to enhance the visibility of the speed limit sign 585. In this way, the disclosed systems, methods, and other embodiments improve infrastructure maintenance by using deep learning logic to recommend a particular maintenance task based on a comparison of map data and vehicle sensor data, which vehicle sensor data is suggestive of what a motorist of the vehicle perceives.

FIG. 1 will now be discussed in full detail as an example environment within which the system and methods disclosed herein may operate. In some instances, the vehicle 100 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 100 as manipulated by a user (e.g., human driver). In one or more arrangements, the vehicle 100 can be a manually-controlled vehicle that is configured to operate in only the manual mode.

In one or more arrangements, the vehicle 100 implements some level of automation in order to operate autonomously or semi-autonomously. As used herein, automated control of the vehicle 100 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 100 along a travel route via a computing system to control the vehicle 100 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 100.

With continued reference to the various components illustrated in FIG. 1, the vehicle 100 includes one or more processors 110. In one or more arrangements, the processor(s) 110 can be a primary/centralized processor of the vehicle 100 or may be representative of many distributed processing units. For instance, the processor(s) 110 can be an electronic control unit (ECU). Alternatively, or additionally, the processors include a central processing unit (CPU), a graphics processing unit (GPU), an ASIC, an microcontroller, a system on a chip (SoC), and/or other electronic processing units that support operation of the vehicle 100.

The vehicle 100 can include one or more data stores 115 for storing one or more types of data. The data store 115 can be comprised of volatile and/or non-volatile memory. Examples of memory that may form the data store 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 115 is a component of the processor(s) 110. In general, the data store 115 is operatively connected to the processor(s) 110 for use thereby. The term “operatively connected,” as used throughout this description, can include direct or indirect connections, including connections without direct physical contact.

In one or more arrangements, the one or more data stores 115 include various data elements to support functions of the vehicle 100, such as semi-autonomous and/or autonomous functions. Thus, the data store 115 may store map data 116 and/or sensor data 119. The map data 116 includes, in at least one approach, maps of one or more geographic areas. In some instances, the map data 116 can include information about roads (e.g., lane and/or road maps), traffic control devices, road markings, structures, features, and/or landmarks in the one or more geographic areas. The map data 116 may be characterized, in at least one approach, as a high-definition (HD) map that provides information for autonomous and/or semi-autonomous functions.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. In one or more arrangements, the map data 116 includes one or more static obstacle maps 118. The static obstacle map(s) 118 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 119 is data provided from one or more sensors of the sensor system 120. Thus, the sensor data 119 may include observations of a surrounding environment of the vehicle 100 and/or information about the vehicle 100 itself. In some instances, one or more data stores 115 located onboard the vehicle 100 store at least a portion of the map data 116 and/or the sensor data 119. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 120 and/or the one or more sensors can be operatively connected to the processor(s) 110, the data store(s) 115, and/or another element of the vehicle 100.

Various examples of different types of sensors will be described herein. However, it will be understood that the embodiments are not limited to the particular sensors described. In various configurations, the sensor system 120 includes one or more vehicle sensors 121 and/or one or more environment sensors. The vehicle sensor(s) 121 function to sense information about the vehicle 100 itself. In one or more arrangements, the vehicle sensor(s) 121 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 100.

As noted, the sensor system 120 can include one or more environment sensors 122 that sense a surrounding environment (e.g., external) of the vehicle 100 and/or, in at least one arrangement, an environment of a passenger cabin of the vehicle 100. For example, the one or more environment sensors 122 sense objects the surrounding environment of the vehicle 100. Such obstacles may be stationary objects and/or dynamic objects. Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 includes one or more radar sensors 123, one or more LIDAR sensors 124, one or more sonar sensors 125 (e.g., ultrasonic sensors), and/or one or more cameras 126 (e.g., monocular, stereoscopic, RGB, infrared, etc.).

Continuing with the discussion of elements from FIG. 1, the vehicle 100 can include an input system 130. The input system 130 generally encompasses one or more devices that enable the acquisition of information by a machine from an outside source, such as an operator. The input system 130 can receive an input from a vehicle passenger (e.g., a driver/operator and/or a passenger). Additionally, in at least one configuration, the vehicle 100 includes an output system 135. The output system 135 includes, for example, one or more devices that enable information/data to be provided to external targets (e.g., a person, a vehicle passenger, another vehicle, another electronic device, etc.).

Furthermore, the vehicle 100 includes, in various arrangements, one or more vehicle systems 140. Various examples of the one or more vehicle systems 140 are shown in FIG. 1. However, the vehicle 100 can include a different arrangement of vehicle systems. It should be appreciated that although particular vehicle systems are separately defined, each or any of the systems or portions thereof may be otherwise combined or segregated via hardware and/or software within the vehicle 100. As illustrated, the vehicle 100 includes a propulsion system 141, a braking system 142, a steering system 143, a throttle system 144, a transmission system 145, a signaling system 146, and a navigation system 147.

The navigation system 147 can include one or more devices, applications, and/or combinations thereof to determine the geographic location of the vehicle 100 and/or to determine a travel route for the vehicle 100. The navigation system 147 can include one or more mapping applications to determine a travel route for the vehicle 100 according to, for example, the map data 116. The navigation system 147 may include or at least provide connection to a global positioning system, a local positioning system or a geolocation system.

In one or more configurations, the vehicle systems 140 function cooperatively with other components of the vehicle 100. For example, the processor(s) 110 and/or automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the navigation and/or maneuvering of the vehicle 100. The processor(s) 110, and/or the automated driving module(s) 160 may control some or all of these vehicle systems 140.

For example, when operating in the autonomous mode, the processor(s) 110 and/or the automated driving module(s) 160 control the heading and speed of the vehicle 100. The processor(s) 110, and/or the automated driving module(s) 160 cause the vehicle 100 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 100 includes one or more actuators 150 in at least one configuration. The actuators 150 are, for example, elements operable to move and/or control a mechanism, such as one or more of the vehicle systems 140 or components thereof responsive to electronic signals or other inputs from the processor(s) 110 and/or the automated driving module(s) 160. The one or more actuators 150 may include motors, pneumatic actuators, hydraulic pistons, relays, solenoids, piezoelectric actuators, and/or another form of actuator that generates the desired control.

As described previously, the vehicle 100 can include one or more modules, at least some of which are described herein. In at least one arrangement, the modules are implemented as non-transitory computer-readable instructions that, when executed by the processor 110, implement one or more of the various functions described herein. In various arrangements, one or more of the modules are a component of the processor(s) 110, or one or more of the modules are executed on and/or distributed among other processing systems to which the processor(s) 110 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 100 may include one or more automated driving modules 160. The automated driving module(s) 160, in at least one approach, receive data from the sensor system 120 and/or other systems associated with the vehicle 100. In one or more arrangements, the automated driving module(s) 160 use such data to perceive a surrounding environment of the vehicle. The automated driving module(s) 160 determine a position of the vehicle 100 in the surrounding environment and map aspects of the surrounding environment. For example, the automated driving module(s) 160 determines the location of obstacles or other environmental features including traffic signs, trees, shrubs, neighboring vehicles, pedestrians, etc.

The automated driving module(s) 160 can be configured to determine travel path(s), current autonomous driving maneuvers for the vehicle 100, future autonomous driving maneuvers and/or modifications to current autonomous driving maneuvers based on data acquired by the sensor system 120 and/or another source. In general, the automated driving module(s) 160 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
infer a perceived infrastructure element by a motorist within an environment based on sensor data collected from a sensor system of a vehicle;
retrieve map data associated with the environment, wherein the map data indicates a mapped infrastructure element; and
recommend a maintenance task to be performed based on the map data and the sensor data.

2. The system of claim 1, wherein:
the sensor data comprises images of the environment; and
the machine-readable instruction to recommend the maintenance task further comprises an instruction that, when executed by the processor, causes the processor to recommend the maintenance task based on a detected discrepancy between the map data and the images of the environment.

3. The system of claim 2, wherein the instruction to recommend the maintenance task based on the detected discrepancy comprises an instruction that, when executed by the processor, causes the processor to identify that the mapped infrastructure element is not captured in an image of the environment of the vehicle.

4. The system of claim 1, wherein:
the sensor data comprises vehicle operational data; and
the machine-readable instruction to recommend the maintenance task further comprises an instruction that, when executed by the processor, causes the processor to recommend the maintenance task based on the map data and the vehicle operational data.

5. The system of claim 1, wherein the maintenance task is recommended based on:
a similarity between the sensor data and historical sensor data collected from other vehicles passing through the environment; and
a previously performed maintenance task associated with the historical sensor data.

6. The system of claim 1, wherein:
the machine-readable instructions further comprise an instruction that, when executed by the processor, causes the processor to retrieve an infrastructure record that indicates a status of the mapped infrastructure element; and
the machine-readable instructions to recommend the maintenance task is further based on the infrastructure record.

7. The system of claim 1, wherein:
the machine-readable instructions further comprise an instruction that, when executed by the processor, causes the processor to retrieve an annotation regarding a historical maintenance task performed within the environment; and
the machine-readable instructions to recommend the maintenance task is further based on the annotation.

8. The system of claim 1, wherein the machine-readable instruction to recommend the maintenance task further comprises an instruction that, when executed by the processor, causes the processor to recommend a repair of the mapped infrastructure element.

9. The system of claim 1, wherein the machine-readable instruction to recommend the maintenance task further comprises an instruction that, when executed by the processor, causes the processor to recommend an environmental repair, wherein the environmental repair increases a visibility of the mapped infrastructure element.

10. The system of claim 1, wherein the machine-readable instruction to recommend the maintenance task further comprises an instruction that, when executed by the processor, causes the processor to recommend a non-road surface maintenance task.

11. A non-transitory machine-readable medium comprising instructions that, when executed by a processor, cause the processor to:
collect sensor data from a sensor system of a vehicle;
infer, from the sensor data, a perceived infrastructure element by a motorist within an environment;
retrieve map data associated with the environment, wherein the map data indicates a mapped infrastructure element; and
recommend, using a neural network model trained to identify maintenance tasks based on the map data and the sensor data, a maintenance task to be performed based on a comparison of the map data and the sensor data.

12. The non-transitory machine-readable medium of claim 11, wherein:
the sensor data comprises images of the environment; and
the instruction to recommend the maintenance task further comprises an instruction that, when executed by the processor, causes the processor to recommend the maintenance task based on a detected discrepancy between the map data and the images of the environment.

13. The non-transitory machine-readable medium of claim 11, wherein the machine-readable medium further comprises an instruction that, when executed by the processor, causes the processor to train the neural network model based on a completed maintenance task and the sensor data.

14. The non-transitory machine-readable medium of claim 11, wherein:
the machine-readable medium further comprises an instruction that, when executed by the processor, causes the processor to retrieve an infrastructure record that indicates a status of the mapped infrastructure element; and
the instruction to recommend the maintenance task is further based on the infrastructure record.

15. The non-transitory machine-readable medium of claim 11, wherein:
the machine-readable medium further comprises an instruction that, when executed by the processor, causes the processor to retrieve an annotation regarding a historical maintenance task performed within the environment; and
the instruction to recommend the maintenance task is further based on the annotation.

16. The non-transitory machine-readable medium of claim 11, wherein the instruction to recommend the maintenance task comprises an instruction that, when executed by the processor, causes the processor to identify that the mapped infrastructure element indicated is not captured in an image of the environment of the vehicle.

17. A method, comprising:
collecting sensor data from a sensor system of a vehicle;
inferring, from the sensor data, a perceived infrastructure element by a motorist within an environment;
retrieving map data associated with the environment, wherein the map data:
indicates a mapped infrastructure element; and
is machine-generated based on sensor data from multiple vehicles traveling through the environment; and
recommending, using a neural network model trained to identify maintenance tasks based on the map data and the sensor data, a maintenance task to be performed based on the map data and the sensor data.

18. The method of claim 17, wherein:
the sensor data comprises images of the environment; and
recommending the maintenance task further comprises recommending the maintenance task based on a detected discrepancy between the map data and the images of the environment.

19. The method of claim 17:
further comprising retrieving an infrastructure record that indicates a status of the mapped infrastructure element; and
wherein recommending the maintenance task is further based on the infrastructure record.

20. The method of claim 17:
further comprising retrieving an annotation regarding a historical maintenance task performed within the environment; and
wherein recommending the maintenance task is further based on the annotation.
